(19) United States
(12) Patent Application Publication
(10) Pub. No.: US 2020/0089297 A1
(43) Pub. Date: Mar. 19, 2020

(54) ELECTRONIC DEVICE, CONTROL DEVICE, AND STORAGE MEDIUM

(71) Applicant: SHARP KABUSHIKI KAISHA, Osaka (JP)

(72) Inventors: HIDENORI KUWAJIMA, Osaka (JP); HISASHI KURODA, Osaka (JP)

(21) Appl. No.: 16/567,572

(22) Filed: Sep. 11, 2019

(30) Foreign Application Priority Data
Sep. 14, 2018 (JP) 2018-172986

(51) Int. Cl. G06F 1/26; G06F 1/3296; G06F 1/28; G06F 13/38

(52) U.S. Cl. CPC G06F 1/266; G06F 1/3296; G06F 2213/0042; G06F 13/382; G06F 1/28

(57) ABSTRACT

An electronic device including: two or more connectors including a first connector and a second connector; and a control section, the control section being configured to request a first external device to change electric power to be supplied to the electronic device by the first external device, in a case where a second external device is connected to the second connector while the first external device is supplying electric power to the electronic device via the first connector.

This Nonprovisional application claims priority under 35 U.S.C. § 119 on Patent Application No. 2018-172986 filed in Japan on Sep. 14, 2018, the entire contents of which are hereby incorporated by reference.

### TECHNICAL FIELD

The present invention relates to an electronic device. The present invention is suitably used particularly as an electronic device for controlling electric power to be supplied in conformity to USB power delivery (USB-PD).

### BACKGROUND ART

As a conventional technique for supplying a high electric power to an electronic device, a technique which employs USB-PD is known. In USB-PD, it is possible to reverse electric power source and sink, since bidirectional transmission of electric power is possible. Accordingly, it is possible for electronic devices, which are connected in conformity to USB-PD, to supply electric power to each other and share electric power with each other. This allows for management of a total electric power of electronic devices (Non-Patent Literature 1).

### CITATION LIST

### Patent Literature

### Non-Patent Literature

[Non-Patent Literature 1]

“USB Power Delivery ROHM BM92Txx series”, [online], [searched on Aug. 1, 2018], the Internet <URL: http://www.rohm.co.jp/documents/11401/3642051/20150916_usbpd.pdf>

### SUMMARY OF INVENTION

### Technical Problem

However, the above conventional technique has a problem in that a connection topology is limited to a cascade topology or a star topology.

In light of the above, an object of an aspect of the present invention is to provide an electronic device which allows for management of a total electric power regardless of a connection topology.

### Solution to Problem

In order to solve the above problem, an electronic device in accordance with an aspect of the present invention is arranged to include: two or more connectors including a first connector and a second connector; and a control section, the control section being configured to request a first external device to change electric power to be supplied to the electronic device by the first external device, in a case where a second external device is connected to the second connector while the first external device is supplying electric power to the electronic device via the first connector.

In order to solve the above problem, an electronic device in accordance with another aspect of the present invention is arranged to include: a connector; and a control section, the control section being configured to transmit, to a first external device connected to the electronic device, an inquiry as to whether or not a reduction in electric power supplied to the first external device is acceptable, in a case where the control section receives, from a second external device connected to the electronic device via the connector, an electric power supply request for more electric power than the electronic device is currently capable of supplying.

### Advantageous Effects of Invention

An aspect of the present invention makes it possible to provide an electronic device which allows for management of a total electric power regardless of a connection topology.

### BRIEF DESCRIPTION OF DRAWINGS

FIG. 1 is a block diagram illustrating a main part configuration of an electronic device in accordance with Embodiment 1 of the present invention.

FIG. 2 is a diagram illustrating a state in which electronic devices in accordance with Embodiment 1 of the present invention are connected to each other.

FIG. 3 is a diagram illustrating a state in which another electronic device is further connected in the state illustrated in FIG. 2 in accordance with Embodiment 1 of the present invention.

FIG. 4 is a sequence diagram illustrating one example of a flow of a series of process steps of an electric power supply changing control in accordance with Embodiment 1 of the present invention.

FIG. 5 is a diagram illustrating a state in which electronic devices in accordance with Additional Example 1 of Embodiment 1 of the present invention are connected to each other.

FIG. 6 is a sequence diagram illustrating one example of a flow of a series of process steps of an electric power supply changing control in accordance with Additional Example 1 of Embodiment 1 of the present invention.

FIG. 7 is a sequence diagram illustrating one example of a flow of a series of process steps of an electric power supply changing control in accordance with Additional Example 2 of Embodiment 1 of the present invention.

FIG. 8 is a diagram illustrating a state in which electronic devices in accordance with Additional Example 3 of Embodiment 1 of the present invention are connected to each other.

FIG. 9 is a sequence diagram illustrating one example of a flow of a series of process steps of an electric power supply changing control in accordance with Additional Example 3 of Embodiment 1 of the present invention.

FIG. 10 is a diagram illustrating a state in which electronic devices in accordance with Embodiment 2 of the present invention are connected to each other.

FIG. 11 is a sequence diagram illustrating one example of a flow of a series of process steps of an electric power supply changing control in accordance with Embodiment 2 of the present invention.

### DESCRIPTION OF EMBODIMENTS

### Embodiment 1

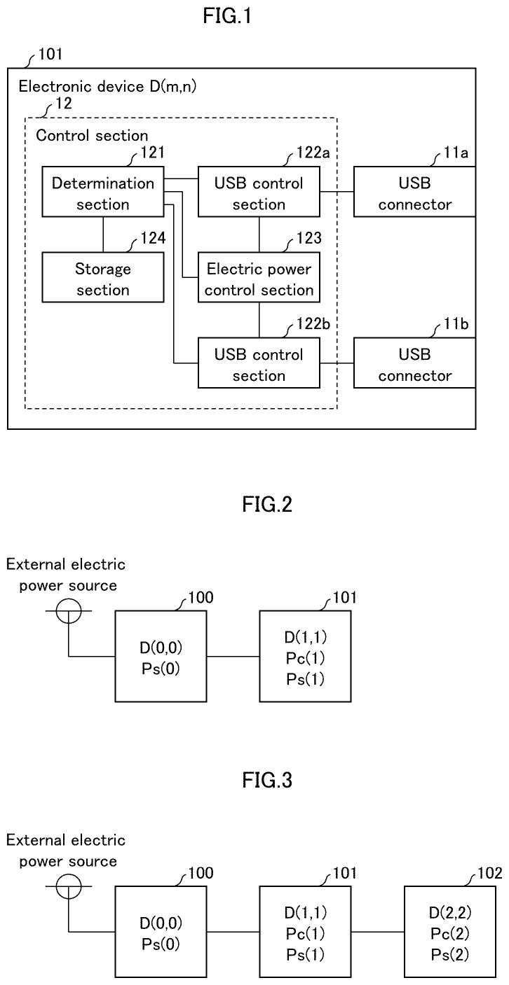

The following will discuss an electronic device in accordance with an embodiment of the present invention, with reference to FIG. 1. FIG. 1 is a block diagram illustrating a main part configuration of an electronic device in accordance with Embodiment 1 of the present invention. As illustrated in FIG. 1, an electronic device 101 includes USB connectors 11a and 11b (two or more connectors) for connecting the electronic device 101 to, for example, an external device(s), and a control section 12 (control section) for controlling the electronic device 101.

1. Configuration of Electronic Device

[USB Connectors]

The USB connectors 11a and 11b are each a connector for connecting the electronic device 101 to an external device via a USB cable or the like. Since the electronic device 101 is connected to the external device via one of the USB connectors 11a and 11b, it can receive electric power from the external device or can supply electric power to the external device. The USB connectors 11a and 11b are each connected to the control section 12 in the electronic device 101. FIG. 1 illustrates, by way of example, a configuration in which the USB connector 11 includes two USB connectors 11a and 11b. Note, however, that the USB connector 11 can alternatively include more than two USB connectors. In Embodiment 1, the USB connectors 11a and 11b are, for example, respective USB Type-C connectors.

[Control Section]

As illustrated in FIG. 1, the control section 12 includes a determination section 121, USB control sections 122a and 122b, an electric power control section 123, and a storage section 124. The control section 12 is configured to control an operation of each of the above sections so as to carry out overall control of the electronic device 1. FIG. 1 illustrates a configuration in which only one (1) control section 12 is provided, but two or more control sections can be alternatively provided.

(Determination Section)

The determination section 121 totally controls the electronic device 101. Specifically, the determination section 121 conducts, for example, the following operations.
Determine electric power necessary for operation of a first electronic device which is newly connected to the electronic device 101 via the USB connector 11a or 11b.
Calculate (i) the first sum of (a) electric power necessary for operation of the electronic device 101 and (b) electric power necessary for operation of the first electronic device or (ii) the second sum of (c) the first sum and (d) electric power necessary for operation of a second electronic device to which the electronic device 101 is supplying electric power.
Instruct the USB control section 122a or 122b to request a third electronic device, which is supplying electric power to the electronic device 101, to change from a current electric power to the first or second sum.
Subtract the electric power necessary for operation of the electronic device 101 from the electric power supplied by the third electronic device.
Instruct the USB control section 122a or 122b to supply, to the first electronic device, electric power obtained as a result of the above subtraction.
Determine whether or not the electric power which is being supplied to the electronic device 101 is larger than the electric power necessary for operation of the electronic device 101.

(USB Control Sections)

The USB control sections 122a and 122b (i) receive respective pieces of information via the USB connectors 11a and 11b and (ii) transmit the pieces of information to the determination section 121. Further, the USB control sections 122a and 122b instruct the USB connectors 11a and 11b, respectively, on the basis of information from the determination section 121. Specifically, the USB control sections 11a and 11b conduct, for example, the following operations.
Recognize that a new electronic device is connected to the electronic device 101, via the USB connector 11a or 11b.
Request the sum of the electric powers obtained by the determination section 121 to another electronic device which is supplying electric power to the electronic device 101.
Recognize the electric power having been supplied to the electronic device 101.
Recognize rejection of the above request.

(Electric Power Control Section)

The electric power control section 123 controls (i) the electric power necessary for operation of the electronic device 101 and (ii) reception or supply of electric power via each of the USB connectors 11a and 11b. Specifically, the electric power control section 123 controls, for example:
the electric power which the electronic device 101 supplies to another electronic device; and
the electric power consumed by the electronic device 101.

(Storage Section)

The storage section 124 stores therein various kinds of information supplied from the control section 12. The information, stored in the storage section 124, is read out by the determination section 121 as appropriate. The memory section 124 is a non-volatile storage medium such as a hard disk, a flash memory, or the like.

2. Operation of Electronic Device

The following description will discuss an example operation of the electronic device 101 in accordance with Embodiment 1, with reference to FIGS. 2 through 4. Note that all of electronic devices 102 through 104 have identical structures to the electronic device 101.

In FIGS. 2 through 4, electronic devices are each given a reference sign D(m, n). In the reference sign D(m, n), m is an integer for distinguishing an electronic device from another electronic device, and m is numbered in the order of connection such that the number is increased by one for each connection. Note that m is 0 for a first electronic device to which electric power is directly supplied by an external electric power source. Then, m is 1 for a second electronic device which is connected to the first electronic device (m=0). Meanwhile, n is an integer indicative of the number of electronic devices which are cascade-connected. Each of the electronic devices has n which is increased by one from n of another electronic device, which is connected to the each electronic device so as to serve as an electric power supply source for the each electronic device. Note that n is 0 for an electronic device to which electric power is directly supplied by an external electric power source. Then, n is 1 for another electronic device to which electric power is directly supplied by the electronic device (n=0).

Further, electric power necessary for operation of an electronic device D(m) is denoted by Pc(m), and electric power which can be supplied by an electronic device D(m, n) is denoted by Ps(m). Ps(0) denotes the maximum electric power which can be supplied by an electronic device D(0, 0). The same applies to FIG. 5 and subsequent drawings.

FIG. 2 is a diagram illustrating a state in which electronic devices in accordance with Embodiment 1 of the present invention are connected to each other. In FIG. 2, the electronic device 101 is being supplied, via one of the USB connectors 11a and 11b (in this case, suppose the USB connector 11a is used), with electric power by an electric power feeding device 100 to which electric power is being supplied by an external electric power source. Note here that the electric power feeding device 100 is supplying, to the electronic device 101, electric power necessary for operation of the electronic device 101.

The control section 12 of the electronic device 101 carries out control for changing electric power to be supplied to the electronic device 101 (hereinafter, also referred to as “electric power supply changing control”), in a case where the control section 12 of the electronic device 101 detects, in the state illustrated in FIG. 2, the electronic device 101 being connected, via the USB connector 11b of the electronic device 101, to an electronic device 102 which is a new external device supplied with no electric power (state illustrated in FIG. 3). In the electric power supply changing control, the control section 12 of the electronic device 101 requests the electric power feeding device 100 to change its electric power supply. FIG. 3 is a diagram illustrating a state in which another electronic device is further connected in the state illustrated in FIG. 2 in accordance with Embodiment 1 of the present invention.

Note that connection or supply of electric power herein means (i) connection via a connector or (ii) electric power supply via a connector, respectively, unless otherwise noted.

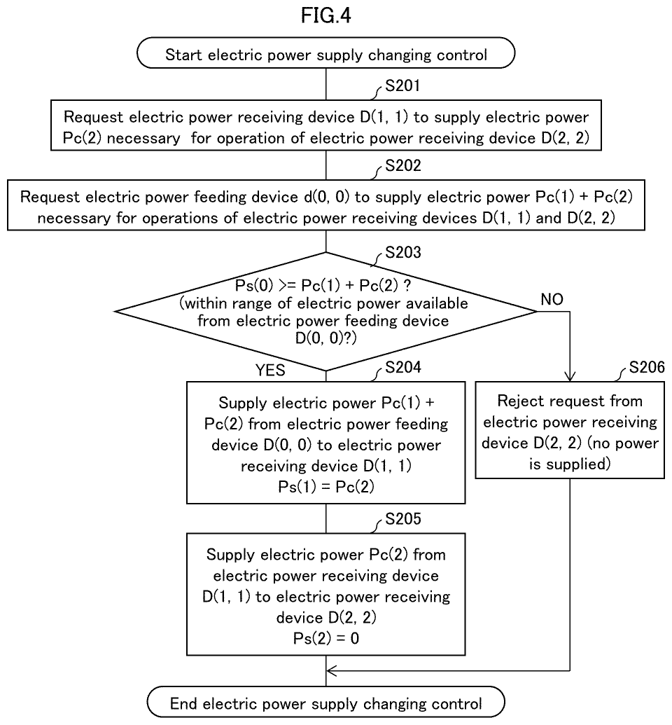

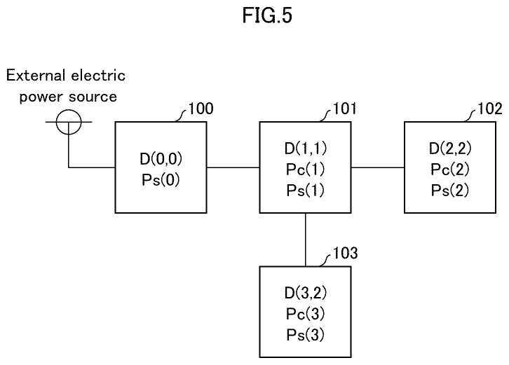

The following description will discuss in detail the electric power supply changing control, with reference to FIG. 4. FIG. 4 is a sequence diagram illustrating an example of a flow of a series of process steps of the electric power supply changing control in accordance with Embodiment 1 of the present invention.

First, the control section 12 of the electronic device 101 receives a request to supply, to the electronic device 102, electric power necessary for operation of the electronic device 102 (Step 201). Next, the control section 12 requests the electric power feeding device 100 to change electric power, supplied to the electronic device 101, from electric power necessary for operation of the electronic device 101 to a total electric power necessary for operations of the electronic device 101 and the electronic device 102 (Step 202).

Then, the electric power feeding device 100 determines whether the electric power feeding device 100 can supply, to the electronic device 101, the electric power which has been requested in Step 202 (Step 203).

In a case where the electric power feeding device 100 determines that the electric power feeding device 100 can supply, to the electronic device 101, the electric power which has been requested in Step 202, the electric power feeding device 100 supplies, to the electronic device 101, the electric power which has been requested in Step 202 (Step 204). Note that the electric power, which has been requested in Step 202, is the total electric power necessary for operations of the electronic device 101 and the electronic device 102. Therefore, the control section 12 of the electronic device 101 carries out control so that the electronic device 101 can supply, to the electronic device 102, electric power which is obtained by subtracting the electric power necessary for operation of the electronic device 101 from the total electric power, that is, the electric power necessary for operation of the electronic device 102. Thereafter, the electronic device 101 supplies, to the electronic device 102, the electric power which has been requested in Step 201 (Step 205). The electric power supply changing control is thus terminated.

In contrast, in a case where the electric power feeding device 100 determines that the electric power feeding device 100 cannot supply, to the electronic device 101, the electric power which has been requested in Step 202, the electric power feeding device 100 rejects the request which has been made in Step 202 (Step 206). In this case, the electric power feeding device 100 does not change the electric power to be supplied to the electronic device 101, so that no electric power is supplied to the electronic device 102. This is the end of the electric power supply changing control. The electric power feeding device 100 keeps supplying, to the electronic device 101, the electric power necessary for operation of the electronic device 101 as before connection of the electronic device 102 to the electronic device 101.

In this case, if the electronic device 102 is disconnected from the electronic device 101, the control section 12 of the electronic device 101 can newly request the electric power feeding device 100 to supply electric power. In this case, the control section 12 of the electronic device 101 requests electric power necessary for operation of only the electronic device 101.

As has been described, (a) in a case where an electronic device, to which electric power is being supplied, is connected to a new external device, to which no electric power is being supplied and (b) in a case where the electronic device is disconnected from the external device, the electronic device can request an upstream electronic device to change electric power to be supplied to the electronic device. Such a request is made upstream, in turn, up to a device to which electric power is directly supplied by an external electric power source. Note that the “upstream” here means “in a direction of an electric device to which electric power is directly supplied by the external electric power source”.

Further, in a case where the request to change the electric power is rejected, the new external device cannot receive electric power but the other electronic devices can remain receiving electric power.

According to Embodiment 1, in a case where a plurality of electronic devices are connected, it is possible to totally manage electric power of connected devices, regardless of how they are connected (cascade connection, star connection, or a combination of such connections). This also makes it possible to efficiently supply the maximum available electric power to more electronic devices.

### Additional Example 1 of Operation of Electronic Device

In FIG. 3, the electronic device 101 is being supplied, via the USB connector 11a, with electric power by the electric power feeding device 100 to which electric power is being supplied by an external electric power source. Further, the electronic device 102 is being supplied, via the USB connector 11b, with electric power by the electronic device 101 to which electric power is being supplied by the electric power feeding device 100.

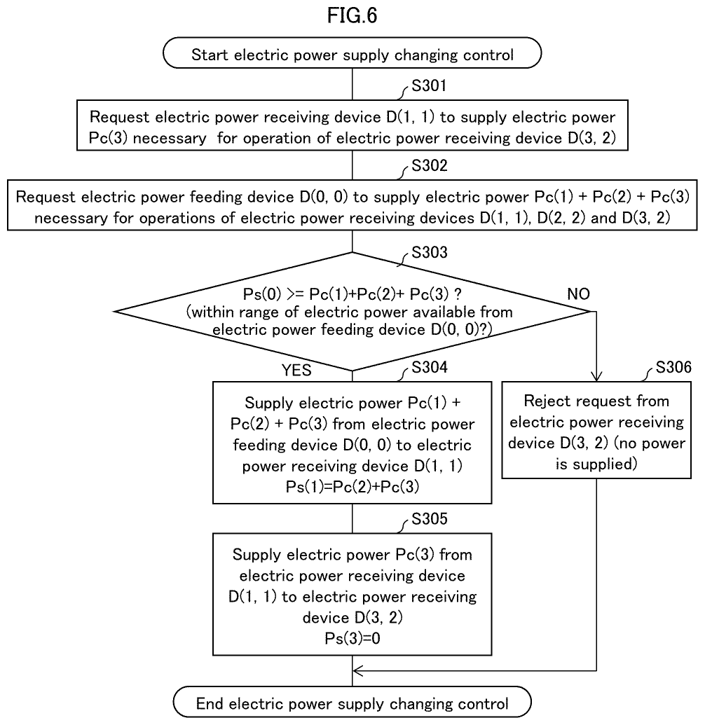

The control section 12 of the electronic device 101 carries out an electric power supply changing control (FIG. 6), in a case where the control section 12 of the electronic device 101 detects, in the above state illustrated in FIG. 3, the electronic device 101 being connected, via a USB connector 11c (USB connector different from the USB connectors 11a and 11b) (not illustrated) of the electronic device 101, to an electronic device 103 that is a new external device to which no electric power is being supplied (state illustrated in FIG. 5). In the electric power supply changing control, the control section 12 of the electronic device 101 requests the electric power feeding device 100 to change its electric power supply. FIG. 5 is a diagram illustrating a state in which electronic devices in accordance with Additional Example 1 of Embodiment 1 of the present invention are connected to each other. FIG. 6 is a sequence diagram illustrating one example of a flow of a series of process steps of the electric power supply changing control in accordance with Additional Example 1 of Embodiment 1 of the present invention.

First, the control section 12 of the electronic device 101 receives a request to supply, to the electronic device 103, electric power necessary for operation of the electronic device 103 (Step 301). Next, the control section 12 requests the electric power feeding device 100 to change electric power, supplied to the electronic device 101, from electric power necessary for operations of the electronic device 101 and the electronic device 102 to a total electric power necessary for operations of the electronic device 101, the electronic device 102 and the electronic device 103 (Step 302).

The electric power feeding device 100 determines whether the electric power feeding device 100 can supply, to the electronic device 101, the electric power which has been requested in Step 302 (Step 303).

In a case where the electric power feeding device 100 determines that the electric power feeding device 100 can supply, to the electronic device 101, the electric power which has been requested in Step 302, the electric power feeding device 100 supplies, to the electronic device 101, the electric power which has been requested in Step 302 (Step 304). Note that the electric power, which has been requested in Step 302, is the total electric power necessary for operations of the electronic device 101, the electronic device 102 and the electronic device 103. Accordingly, the control section 12 of the electronic device 101 carries out control so as to allow the electronic device 101 to supply, to the electronic device 102, electric power necessary for operation of the electronic device 102 and to supply, to the electronic device 103, the electric power necessary for operation of the electronic device 103. Thereafter, the electronic device 101 supplies, to the electronic device 103, the electric power which has been requested in Step 301 (Step 305). The electric power supply changing control is thus terminated.

In contrast, in a case where the electric power feeding device 100 determines that the electric power feeding device 100 cannot supply, to the electronic device 101, the electric power which has been requested in Step 302, the electric power feeding device 100 rejects the request which has been made in Step 302 (Step 306). In this case, the electric power feeding device 100 does not change the electric power to be supplied to the electronic device 101, so that no electric power is supplied to the electronic device 103. This is the end of the electric power supply changing control.

Note that in either of the above cases, the electronic device 101 is supplied with electric power necessary for operation of the electronic device 101, and the electronic device 102 is supplied with electric power necessary for operation of the electronic device 102.

As has been described, in a case where an electronic device, to which electric power is being supplied, is connected to a new external device, to which no electric power is being supplied, the electronic device requests an upstream electronic device to change electric power to be supplied to that electronic device. Such a request is made upstream in turn, up to a device to which electric power is directly supplied by an external electric power source.

Therefore, in Embodiment 1, in a case where a plurality of electronic devices are connected to each other, it is possible to totally manage electric power of connected devices, regardless of how they are connected (cascade connection, star connection, or a combination of such connections). This also makes it possible to efficiently supply the maximum available electric power to more electronic devices.

### Additional Example 2 of Operation of Electronic Device

The electric power feeding device 100 in Embodiment 1 can have a structure similar to that of the electronic device 101. Note however that the electric power feeding device 100 is directly supplied with electric power by an external electric power source. The following will discuss a case where a new external device, to which no electric power is being supplied, is connected to the electric power feeding device 100, to which electric power is being directly supplied by the external electric power source and which has a structure similar to that of the electronic device 101.

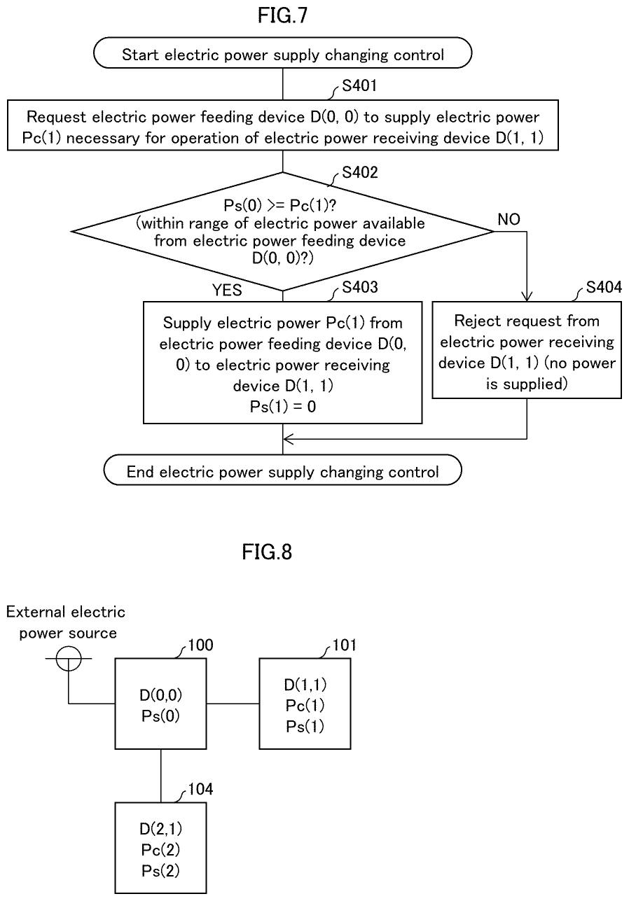

In a stage in which the electric power feeding device 100 is connected, as in the state illustrated in FIG. 2, to the electronic device 101 that is a new external device to which no electric power is being supplied, an electric power supply changing control is carried out as illustrated in FIG. 7. FIG. 7 is a sequence diagram illustrating one example of a flow of a series of process steps of the electric power supply changing control in accordance with Additional Example 2 of Embodiment 1 of the present invention.

First, the electric power feeding device 100 receives a request to supply, to the electronic device 101, electric power necessary for operation of the electronic device 101 (Step 401). Next, the electric power feeding device 100 determines whether the electric power feeding device 100 can supply the electronic device 101 with the electric power which has been requested in Step 401 (Step 402).

In a case where the electric power feeding device 100 determines that the electric power feeding device 100 can supply, to the electronic device 101, the electric power which has been requested, the electric power feeding device 100 supplies, to the electronic device 101, the electric power which has been requested in Step 401 (Step 403). The electric power supply changing control is thus terminated.

In contrast, in a case where the electric power feeding device 100 determines that the electric power feeding device 100 cannot supply, to the electronic device 101, the electric power which has been requested, the electric power feeding device 100 rejects the request which has been made in Step 401 (Step 404). In this case, the electric power feeding device 100 supplies no electric power to the electronic device 101. In other words, no electric power is supplied to the electronic device 101. This is the end of the electric power supply changing control.

### Additional Example 3 of Operation of Electronic Device

The following will discuss a case where a new external device 104, to which no electric power is being supplied, is connected to the electric power feeding device 100, to which electric power is being directly supplied by an external electric power source and which has a structure similar to that of the electronic device 101, in a state in which the electronic device 100 has been already connected to the electronic device 101.

In FIG. 2, the electronic device 101 is being supplied, via one of the USB connectors 11a and 11b (in this case, suppose the USB connector 11a is used), with electric power by the electric power feeding device 100 to which electric power is being supplied by the external electric power source. The electric power feeding device 100 supplies, to the electronic device 101, electric power necessary for operation of the electronic device 101.

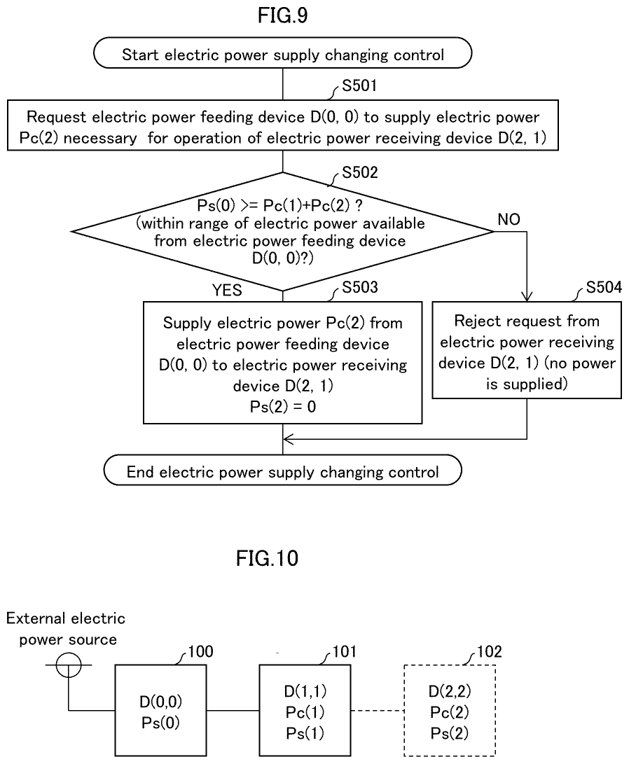

In a case where the electric power feeding device 100 is connected, in the state illustrated in FIG. 2, to the electronic device 104 that is a new external device to which no electric power is being supplied (FIG. 8), an electric power supply changing control is carried out as illustrated in FIG. 9. FIG. 8 is a diagram illustrating a state in which electronic devices in accordance with Additional Example 3 of Embodiment 1 of the present invention are connected to each other. FIG. 9 is a sequence diagram illustrating one example of a flow of a series of process steps of the electric power supply changing control in accordance with Additional Example 3 of Embodiment 1 of the present invention.

First, the electric power feeding device 100 receives a request to supply, to the electronic device 104, electric power necessary for operation of the electronic device 104 (Step 501). The electric power feeding device 100 determines whether the electric power feeding device 100 can supply the electric power which has been requested in Step 501 (Step 502). Since the electric power feeding device 100 here is already supplying electric power to the electronic device 101, the electric power feeding device 100 determines in Step 502 whether the electric power feeding device 100 can supply a total electric power necessary for operations of the electronic device 101 and the electronic device 104.

In a case where the electric power feeding device 100 determines that the electric power feeding device 100 can supply the electric power which has been requested, the electric power feeding device 100 supplies, to the electronic device 104, the electric power which has been requested in Step 501 (Step 503). The electric power supply changing control is thus terminated.

In contrast, in a case where the electric power feeding device 100 determines that the electric power feeding device 100 cannot supply the electric power which has been requested, the electric power feeding device 100 rejects the request which has been made in Step 501 (Step 504). In this case, the electric power feeding device 100 does not change the electric power to be supplied to the electronic device 101, and no electric power is supplied to the electronic device 104. This is the end of the electric power supply changing control.

Note that in either of the cases, the electronic device 101 is supplied with the necessary electric power for operation of the electronic device 101.

### Embodiment 2

The following description will discuss in detail another embodiment of the present invention. For convenience of description, members having functions identical to those of Embodiment 1 are assigned identical referential numerals and their descriptions are omitted.

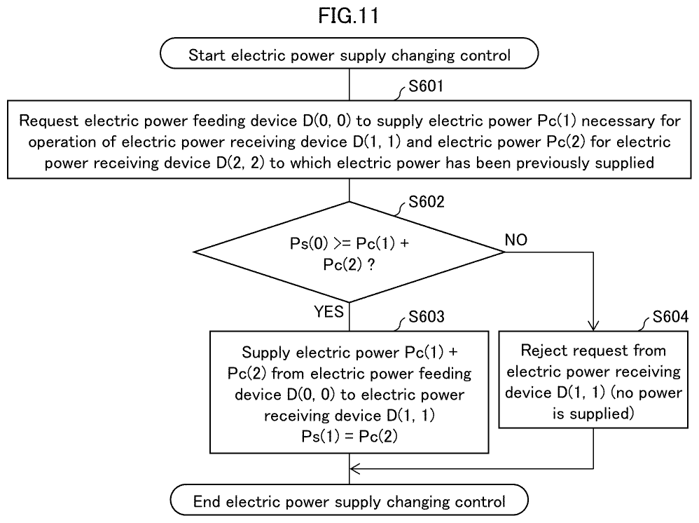

An electronic device 101 in accordance with Embodiment 2 of the present invention can be configured to store, in a storage section 124, electric power which was requested by an electronic device 102 when the electronic device 102 was connected to the electronic device 101 in the past (FIG. 10). In this arrangement, when the electronic device 101 is connected to an electric power feeding device 100, an electric power supply changing control is carried out as illustrated in FIG. 11. FIG. 10 is a diagram illustrating a state in which electronic devices in accordance with Embodiment 2 of the present invention are connected to each other. FIG. 11 is a sequence diagram illustrating one example of a flow of a series of process steps of the electric power supply changing control in accordance with Embodiment 2 of the present invention.

First, in a case where the electronic device 101 is connected to the electric power feeding device 100, the electric power feeding device 100 is requested to supply, to the electronic device 101, a total electric power necessary for operations of the electronic device 101 and the electronic device 102 (Step 601). The electric power feeding device 100 determines whether the electric power feeding device 100 can supply the electric power which has been requested in Step 601 (Step 602).

In a case where the electric power feeding device 100 determines that the electric power feeding device 100 can supply, to the electronic device 101, the electric power which has been requested, the electric power feeding device 100 supplies, to the electronic device 101, the electric power which has been requested in Step 601 (Step 603). The electric power supply changing control is thus terminated.

In contrast, in a case where the electric power feeding device 100 determines that the electric power feeding device 100 cannot supply the electric power which has been requested, the electric power feeding device 100 rejects the request which has been made in Step 601 (Step 604). In this case, the electric power feeding device 100 does not change the electric power to be supplied to the electronic device 101, so that no electric power is supplied to the electronic device 101. This is the end of the electric power supply changing control.

Note that after Step 604, the control section 12 of the electronic device 101 can newly request the electric power feeding device 100 to supply electric power. In this case, the control section 12 of the electronic device 101 requests electric power necessary for operation of only the electronic device 101.

In a case where electronic devices are connected to each other, it is likely that the electronic devices having been previously connected to each other are connected in the order which is the same as that of a previous connection of the electronic devices. Accordingly, in Embodiment 2, in a case where electronic devices which have been previously connected are connected again as in the previous connection of the electronic devices, it is possible to omit steps of carrying out the electric power supply changing control (e.g., Steps 601 and 602 in FIG. 11). Even in such a case where the electric power supply changing control is omitted, the electronic devices can be supplied with electric power (Step 603 in FIG. 11).

Furthermore, even in a case where a request for supply of electric power is rejected in Embodiment 2, it is possible to increase a chance of supplying electric power to an electronic device newly added, by newly requesting electric power necessary for operation of only the electronic device which is actually connected.

Note that the electronic device newly added is highly likely to be an electronic device which a user wants to use the most at the point when the electronic device is added. Therefore, convenience for the user can be enhanced by an arrangement in which, after rejection of a request for electric power, another request for electric power is newly made to the electric power feeding device.

### Embodiment 3

The following description will discuss in detail still another embodiment of the present invention.

An electric power feeding device 100 in Embodiment 3 can have a structure similar to that of an electronic device 101. Note that the electric power feeding device 100 is directly supplied with electric power by an external electric power source. Here, in a case where (i) the electric power feeding device 100 is connected with a newly added electronic device and (ii) the electric power feeding device 100 is requested to supply more electric power than the electric power feeding device 100 can currently supply, a control section of the electric power feeding device 100 transmits, to all electronic devices to which the electric power feeding device 100 is currently supplying electric power, an inquiry if a reduction in electric power supplied to each of the electronic devices is acceptable. In one example case in which such an inquiry is made, the inquiry is made via a connector or a USB cable.

The following will discuss an inquiry process. Note that, in a case where electric power which the electric power feeding device 100 is requested to supply is not more than electric power which the electric power feeding device 100 can currently supply, the electric power feeding device 100 certainly supplies electric power to the newly added electronic device as described above.

When the electronic devices receive the inquiry from the electric power feeding device 100, a control section of each of the electronic devices determines whether the electric power supplied to the electric power feeding device 100 can be reduced. In a case where the control section of the electronic device determines that the electric power supplied to the electronic device can be reduced, the electronic device outputs determination information indicative of a determination result that the electric power supplied to that electronic device can be reduced. The determination information thus outputted is transmitted to the electric power feeding device 100.

In a case where (i) any one of the electronic devices outputs, in response to the above inquiry, determination information that electric power supplied to that electronic device can be changed and (ii) the control section of the electric power feeding device 100 receives that determination information, the control section of the electric power feeding device 100 carries out control so as to reduce the electric power which is supplied to that electronic device. As a result, in a case where the electric power feeding device 100 becomes capable of supplying a total electric power requested by all the electronic devices including the newly added electronic device, the electronic device power feeding device 100 can supply electric power to the newly added electronic device.

Note that in the above inquiry process, when an electronic device outputs information that electric power supplied to that electronic device can be changed, the electronic device outputs, to the electric power feeding device 100, electric power which can be reduced (in other words, an excess electric power) at the same time. The electric power feeding device 100, having received the electric power which can be reduced, newly supplies electric power to each electronic device with reference to the electric power which can be reduced. At this time, a control section 12 of the electronic device 101, to which the newly added electronic device is connected, newly carries out an electric power supply changing control. In the electric power supply changing control, the control section 12 of the electronic device 101 requests the electric power feeding device 100 to change the electric power to be supplied. As a result, it is determined whether electric power is supplied to that newly added electronic device. The electric power supply changing control in this case is carried out with the use of a process similar to that illustrated in FIG. 4 or 6. As a result of carrying out the above process, for example, the electric power feeding device 100 rejects a request from the newly added electronic device, in a case where, although 100 W is requested by the newly added electronic device, only less than 100 W is accumulated as an excess electric power.

As described above, in a case where an electric power feeding device is requested by a newly added electronic device to supply, to this newly added electronic device, more electric power than the electric power feeding device can currently supply, the electric power feeding device asks each electronic device if there is any excess electric power. Then, in a case where there is an excess electric power, the electric power feeding device supplies that excess electric power to the newly added electronic device. This can increase a chance of supplying electric power to the newly added electronic device.

Note that since the newly added electronic device is highly likely to be an electronic device which a user wants to use the most at the point when the newly added electronic device is connected, the above arrangement makes it possible to enhance convenience for the user.

### Software Implementation Example

The control section 12 of the electronic device 101 (in particular the determination section 121 and the electric power control section 123) can be used as a control device. Further, the control device can be realized by a logic circuit (hardware) provided in an integrated circuit (IC chip) or the like or can be alternatively realized by software.

In the latter case, the control device includes a computer that executes instructions of a program that is software realizing the foregoing functions. The computer, for example, includes at least one processor (control device) and at least one computer-readable storage medium storing the program. An object of the present invention can be achieved by the processor of the computer reading and executing the program stored in the storage medium. Examples of the processor encompass a central processing unit (CPU). Examples of the storage medium encompass a “non-transitory tangible medium” such as a read only memory (ROM), a tape, a disk, a card, a semiconductor memory, and a programmable logic circuit. The computer may further include a random access memory (RAM) or the like in which the program is loaded. Further, the program may be supplied to or made available to the computer via any transmission medium (such as a communication network and a broadcast wave) which allows the program to be transmitted. Note that an aspect of the present invention can also be achieved in the form of a computer data signal in which the program is embodied via electronic transmission and which is embedded in a carrier wave.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

Aspects of the present invention can also be expressed as follows:

An electronic device in accordance with Aspect 1 of the present invention is arranged to include: two or more connectors including a first connector and a second connector; and a control section, the control section being configured to request a first external device to change electric power to be supplied to the electronic device by the first external device, in a case where a second external device is connected to the second connector while the first external device is supplying electric power to the electronic device via the first connector.

An electronic device in accordance with Aspect 2 of the present invention can be arranged such that in Aspect 1: the control section is configured to receive an electric power supply request from the second external device via the second connector; and the control section is configured to request the first external device to change the electric power, which is to be supplied to the electronic device by the first external device, to become a sum of electric power indicated by the electric power supply request received from the second external device and electric power needed by the electronic device.

An electronic device in accordance with Aspect 3 of the present invention can be arranged such that in Aspect 2: the control section is configured to carry out control so that electric power is supplied to the second external device, in a case where, after the control section has requested the first external device to change the electric power to be supplied to the electronic device by the first external device, the control section determines that a value obtained by subtracting electric power needed by the electronic device from the electric power supplied to the electronic device by the first external device is not less than electric power requested by the second external device; and the control section is configured to carry out control so that no electric power is supplied to the second external device, in a case where, after the control section has requested the first external device to change the electric power to be supplied to the electronic device by the first external device, the control section determines that the value obtained by subtracting the electric power needed by the electronic device from the electric power supplied to the electronic device by the first external device is less than the electric power requested by the second external device.

An electronic device in accordance with Aspect 4 of the present invention can be arranged such that in Aspect 1 or 2: the control section is configured to determine whether or not a reduction in electric power supplied to the electric device is acceptable, in a case where the control section receives an inquiry as to whether or not the reduction of electric power supplied to the electric device is acceptable; and the control section is configured to output determination information indicative of a determination result that the reduction of electric power supplied to the electric device is acceptable, in a case where the control section determines that the reduction of electric power supplied to the electric device is acceptable.

An electronic device in accordance with Aspect 5 of the present invention can be arranged to further include a storage section in any one of Aspects 1 through 4, the storage section being configured to store therein electric power indicated by an electric power supply request received from the second external device which has been connected previously, and the control section being configured to request the first external device to change the electric power to be supplied to the electronic device by the first external device, with reference to the electric power stored in the storage section.

An electronic device in accordance with Aspect 6 of the present invention is arranged to include: one or more connector; and a control section, the control section being configured to transmit, to a first external device connected to the electronic device, an inquiry as to whether or not a reduction in electric power supplied to the first external device is acceptable, in a case where the control section receives, from a second external device connected to the electronic device via the connector, an electric power supply request for more electric power than the electronic device is currently capable of supplying.

An electronic device in accordance with Aspect 7 of the present invention can be arranged such that in Aspect 6: the control section is configured to reduce the electric power supplied to the first external device, in a case where the control section receives, from the first external device, determination information indicating that the reduction in electric power supplied to the first external device is acceptable.

A control device in accordance with Aspect 8 of the present invention is a control device for use in an electronic device including two or more connectors including a first connector and a second connector, the control device being configured to request a first external device to change electric power to be supplied to the electronic device by the first external device, in a case where a second external device is connected to the second connector while the first external device is supplying electric power to the electronic device via the first connector.

A control device in accordance with Aspect 9 of the present invention is a control device for use in an electronic device including a connector, the control device being configured to transmit, to a first external device connected to the electronic device, an inquiry as to whether or not a reduction in electric power supplied to the first external device is acceptable, in a case where the control section receives, from a second external device connected to the electronic device via the connector, an electric power supply request for more electric power than the electronic device is currently capable of supplying.

A non-transitory storage computer-readable medium in accordance with Aspect 10 of the present invention is arranged to store therein a program for causing a computer to function as the electronic device described in the above Aspect 1, the program causing the computer to function as the control section.

A non-transitory computer-readable storage medium in accordance with Aspect 11 of the present invention is arranged to store therein a program for causing a computer to function as the electronic device recited in claim 6, the program causing the computer to function as the control section.

### REFERENCE SIGNS LIST

11, 11a, 11b USB connector
12 control section
100 electric power feeding device
101, 102, 103, 104 electronic device
121 determination section
122a, 122b USB control section
123 electric power control section
124 storage section

1. An electronic device comprising:
two or more connectors including a first connector and a second connector; and
a control section,
the control section being configured to request a first external device to change electric power to be supplied to the electronic device by the first external device, in a case where a second external device is connected to the second connector while the first external device is supplying electric power to the electronic device via the first connector.

2. The electronic device as set forth in claim 1, wherein:
the control section is configured to receive an electric power supply request from the second external device via the second connector; and
the control section is configured to request the first external device to change the electric power, which is to be supplied to the electronic device by the first external device, to become a sum of electric power indicated by the electric power supply request received from the second external device and electric power needed by the electronic device.

3. The electronic device as set forth in claim 1, wherein:
the control section is configured to carry out control so that electric power is supplied to the second external device, in a case where, after the control section has requested the first external device to change the electric power to be supplied to the electronic device by the first external device, the control section determines that a value obtained by subtracting electric power needed by the electronic device from the electric power supplied to the electronic device by the first external device is not less than electric power requested by the second external device; and
the control section is configured to carry out control so that no electric power is supplied to the second external device, in a case where, after the control section has requested the first external device to change the electric power to be supplied to the electronic device by the first external device, the control section determines that the value obtained by subtracting the electric power needed by the electronic device from the electric power supplied to the electronic device by the first external device is less than the electric power requested by the second external device.

4. The electronic device as set forth in claim 1, wherein:
the control section is configured to determine whether or not a reduction in electric power supplied to the electric device is acceptable, in a case where the control section receives an inquiry as to whether or not the reduction of electric power supplied to the electric device is acceptable; and
the control section is configured to output determination information indicative of a determination result that the reduction of electric power supplied to the electric device is acceptable, in a case where the control section determines that the reduction of electric power supplied to the electric device is acceptable.

5. An electronic device as set forth in claim 1, further comprising:
a storage section,
the storage section being configured to store therein electric power indicated by an electric power supply request received from the second external device which has been connected previously, and
the control section being configured to request the first external device to change the electric power to be supplied to the electronic device by the first external device, with reference to the electric power stored in the storage section.

6. An electronic device comprising:
a connector; and
a control section,
the control section being configured to transmit, to a first external device connected to the electronic device, an inquiry as to whether or not a reduction in electric power supplied to the first external device is acceptable, in a case where the control section receives, from a second external device connected to the electronic device via the connector, an electric power supply request for more electric power than the electronic device is currently capable of supplying.

7. The electronic device as set forth in claim 6, wherein:
the control section is configured to reduce the electric power supplied to the first external device, in a case where the control section receives, from the first external device, determination information indicating that the reduction in electric power supplied to the first external device is acceptable.

8. A control device for use in an electronic device including two or more connectors including a first connector and a second connector,
the control device being configured to request a first external device to change electric power to be supplied to the electronic device by the first external device, in a case where a second external device is connected to the second connector while the first external device is supplying electric power to the electronic device via the first connector.

9. A control device for use in an electronic device including a connector,
the control device being configured to transmit, to a first external device connected to the electronic device, an inquiry as to whether or not a reduction in electric power supplied to the first external device is acceptable, in a case where the control section receives, from a second external device connected to the electronic device via the connector, an electric power supply request for more electric power than the electronic device is currently capable of supplying.

10. A non-transitory computer-readable storage medium storing therein a program for causing a computer to function as the electronic device recited in claim 1, the program causing the computer to function as the control section.

11. A non-transitory computer-readable storage medium storing therein a program for causing a computer to function as the electronic device recited in claim 6, the program causing the computer to function as the control section.
